(19) United States
(12) Patent Application Publication
(10) Pub. No.: US 2026/0288642 A1
(43) Pub. Date: Sep. 24, 2026

(54) INTERLEAVING OF INDIRECT PREFETCHES WITH INDIRECT DRAWS AND DISPATCHES AT A COMMAND BUFFER

(71) Applicant: ADVANCED MICRO DEVICES, INC., Santa Clara, CA (US)

(72) Inventors: Rakan Khraisha, Orlando, FL (US); Alexander Fuad Ashkar, Winter Park, FL (US); Harry J Wise, Orlando, FL (US); Manu Rastogi, Casselberry, FL (US)

(21) Appl. No.: 19/088,111

(22) Filed: Mar. 24, 2025

(51) Int. Cl. G06F 12/0862

(52) U.S. Cl. CPC G06F 12/0862; G06F 2212/6026

(57) ABSTRACT

An indirect command buffer mitigates memory latencies associated with fetching data, arguments, and state by interleaving prefetch packets with indirect draw commands and/or indirect dispatch commands. The indirect command buffer is populated by one of a driver of a CPU and a command processor of a parallel processor using an interleaving pattern for the prefetch packets and the indirect draw and/or dispatch commands that is based on physical constraints of local memory at the parallel processor

### BACKGROUND

Conventional processing systems include a central processing unit (CPU) and a parallel processor such as a graphics processing unit (GPU) that implements pipelines to perform audio, video, and graphics applications, as well as general purpose computing for applications such as artificial intelligence (AI). Applications are represented as a static programming sequence of microprocessor instructions grouped in a program or as processes with a set of resources that are allocated to the application during the lifetime of the application. The CPU performs user mode operations for applications including multimedia applications. For example, an operating system (OS) executing on the CPU initiates graphics processing by issuing application programming interface (API) calls (e.g., draw calls) to one or more parallel processors.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including a parallel processor having a command buffer configured to store prefetch packets that are interleaved with indirect draw and/or indirect dispatch commands in accordance with some embodiments.

FIG. 2 is a block diagram of an interleaved indirect command buffer in accordance with some embodiments.

FIG. 3 is a block diagram illustrating interleaving of indirect command buffers based on local memory constraints in accordance with some embodiments.

FIG. 4 is a flow diagram illustrating a method for interleaving prefetch packets with indirect draw and/or indirect dispatch commands at an indirect command buffer in accordance with some embodiments.

### DETAILED DESCRIPTION

A command buffer is a data structure containing instructions or commands to be executed by a parallel processor, along with associated data. An indirect command buffer stores indirect draw commands and/or indirect dispatch commands that include the location of data, shader arguments (referred to herein as arguments), and state (i.e., context) that a parallel processor such as a graphics processing unit (GPU) or accelerator uses to execute the draw and dispatch commands, rather than storing the actual data, arguments, and state. A draw call (also referred to herein as a draw command) is a command that is generated by the CPU and transmitted to the parallel processor to instruct the parallel processor to render an object in a frame (or a portion of an object). The draw call includes information defining tasks, registers, textures, states, shaders, rendering objects, buffers, and the like that are used by the parallel processor (or a shader engine of the parallel processor) to render the object or portion thereof. The parallel processor renders the object to produce values of pixels that are provided to a display, which uses the pixel values to display an image that represents the rendered object. A dispatch command is a command that obtains its arguments from a buffer. An indirect draw command is a draw command that includes a pointer to a location in memory that stores the data, arguments, and state that are used in executing the draw command, but not the actual data, arguments, and state. Similarly, an indirect dispatch command stores a pointer to a location in memory that stores the data and arguments for execution of the dispatch command, but not the actual data and arguments.

Before a parallel processor can execute an indirect draw command or an indirect dispatch command, the data, arguments, and state used in executing the draw call or dispatch command must be loaded, e.g., from main memory, to a cache or other memory that is local to the parallel processor. To this end, prefetching is often implemented in processing systems to speed up and/or improve the performance of the processing system in executing applications. For example, many parallel processors include caches capable of storing data needed for the execution of applications. As these caches typically have lower storage capacity than main memory, the processing system is not always able to store all the data associated with an application solely in cache memory local to the parallel processor. Accordingly, as the processing system initiates execution of an application (or during execution of the application), a command processor or one or more prefetchers can fetch certain data from main memory in anticipation of the application using this data. The command processor or prefetcher can then store data in one or more caches for faster access than main memory, thereby potentially improving the application's performance. To ensure that the data, arguments, and state needed for executing the draw calls and dispatches is available at local on-chip (cache) memory when the parallel processor executes the draw calls and dispatches, the command buffer also stores prefetch packets. The prefetch packets include instructions to speculatively fetch data, arguments, and/or state that may be needed by the indirect draw or indirect dispatch commands that are also included in the command buffer.

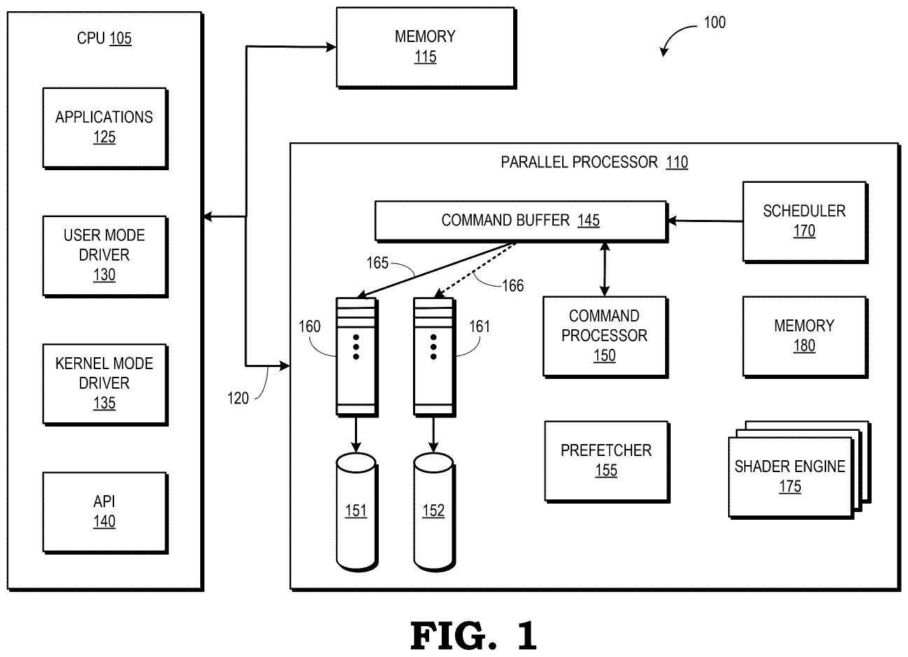

An indirect command buffer can thus include prefetch commands, indirect draw commands, and indirect dispatch commands. However, if the indirect draw commands and the indirect dispatch commands are respectively grouped together in the indirect command buffer, there can be memory latencies associated with fetching data, arguments, and/or state needed for the indirect draw and dispatch commands. FIGS. 1-4 illustrate techniques to mitigate memory latencies associated with fetching data, arguments, and state by interleaving prefetch commands (also referred to herein as prefetch packets) with indirect draw commands and indirect dispatch commands at an indirect command buffer. By interleaving prefetch commands with indirect draws and dispatches at a command buffer, the command buffer effectively hides memory latencies, minimizes stalls, and enhances utilization of the parallel processor and memory bandwidth.

In some implementations, the interleaving includes populating the command buffer with at least one prefetch command followed by at least one indirect draw command or at least one indirect dispatch command. Although the command buffer may include slots for up to a certain number of prefetch commands (e.g., 32 prefetch commands), the amount of data specified by the sum of each of the prefetch commands in the command buffer is limited by an amount of memory allocated to store data fetched in response to the prefetch commands. In other words, if the prefetch commands populating the command buffer direct the command processor or prefetcher to prefetch an amount of data that fills the amount of memory allocated to store data in response to the prefetch commands, no additional prefetch commands can be included in the command buffer, as doing so would cause the amount of prefetched data to exceed the allocated memory.

The command buffer is populated by one or both of a driver of a CPU and a shader engine of the parallel processor in some implementations. The driver and/or shader engine set an interleaving pattern for the commands that is based on physical constraints of local memory at the parallel processor in some implementations. For example, if the data indicated by the prefetch commands is to be loaded to a local memory of the parallel processor that can hold up to N 32-bit double words (referred to herein as DWORDS, i.e., 2×1 WORD, which is 16 bits), the interleaving pattern set by the driver and/or shader engine can include only as many prefetch commands as will prefetch N DWORDS. In some implementations, the interleaving pattern selected by the driver and/or shader engine alternates a first number of prefetch commands with a second number of indirect draw commands or indirect dispatch commands.

As described earlier, the number of prefetch commands may be limited by the amount of data to be prefetched in response to the prefetch commands. In addition, the number of prefetch commands included in the interleaving pattern may be further based on an amount of prefetched data that is consumed by the indirect draw commands and the indirect dispatch commands that follow the prefetch command(s). For example, in some implementations, the amount of data specified by a prefetch packet may be greater than the amount of data actually consumed by a subsequent draw or dispatch command. In such cases, the excess prefetched data may be discarded if it cannot be used by a different subsequent draw or dispatch command. Any discarded data may be overwritten by data prefetched in response to another prefetch packet, thereby effectively freeing up space in the local memory for additional prefetch packets. Accordingly, the number of prefetch packets included in the interleaving pattern may be adjusted based on the amount of data consumed by indirect draw or dispatch commands in the indirect command buffer.

FIG. 1 is a block diagram illustrating a processing system 100 that implements interleaved indirect command buffers according to some embodiments. The processing system 100 includes a central processing unit (CPU) 105 for executing instructions such as instructions that generate draw calls and one or more parallel processors 110 such as a graphics processing unit (GPU) or accelerator for performing graphics processing and, in some embodiments, general purpose computing. The processing system 100 also includes a memory 115 such as a system memory (also referred to as main memory), which is implemented as dynamic random access memory (DRAM), static random access memory (SRAM), nonvolatile RAM, or other type of memory. The CPU 105, the parallel processor 110, and the memory 115 communicate over an interface 120 that is implemented using a bus such as a peripheral component interconnect (PCI, PCI-e) bus. However, other embodiments of the interface 120 are implemented using one or more of a bridge, a switch, a router, a trace, a wire, or a combination thereof. The processing system 100 is implemented in devices such as a computer, a server, a laptop, a tablet, a smart phone, and the like.

The CPU 105 executes processes such as one or more applications 125 that generate commands, a user mode driver 130, a kernel mode driver 135, and other drivers. The applications 125 include applications that utilize the functionality of the parallel processor 110, such as applications that generate work in the processing system 100 or an operating system (OS). Some embodiments of the application 125 generate commands that are provided to the parallel processor 110 over the interface 120 for execution. For example, the application 125 can generate commands that are executed by the parallel processor 110 to render a graphical user interface (GUI), a graphics scene, or other image or combination of images for presentation to a user.

The processing system 100 includes one or more parallel processors 110 such as a GPU or accelerator. An accelerator is a parallel processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. In some implementations, accelerators are separate devices that are included as part of a computer. In other implementations such as accelerated processing units (APUs), parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 110 is also used for general-purpose computing. For instance, the parallel processor 110 can be used to implement machine learning algorithms such as one or more implementations of a neural network as described herein. In some cases, operations of multiple parallel processor 110 are coordinated to execute a machine learning algorithm, such as if a parallel processor 110 does not possess enough processing power to run the machine learning algorithm on its own. The multiple parallel processors 110 communicate over one or more network interfaces (not shown in FIG. 1 in the interest of clarity) such as a network switch or other network device (e.g., a smart NIC).

The parallel processor 110 implements multiple processing elements referred to as shader engines 175, wherein each shader engine 175 includes a respective quantity of compute units that are configured to execute instructions concurrently or in parallel. The parallel processor 110 also includes an internal (or on-chip) memory 180 that includes a translation lookaside buffer (TLB) and a local data store (LDS), as well as caches, registers, or buffers utilized by the compute units. The internal memory 180 is implemented as SRAM and stores data structures that describe tasks executing on one or more of the compute units in some embodiments. In the illustrated embodiment, the parallel processor 110 communicates with the memory 115 over the interface 120. However, some embodiments of the parallel processor 110 communicate with the memory 115 over a direct connection or via other buses, bridges, switches, routers, and the like. The parallel processor 110 can execute instructions stored in the memory 115 and the parallel processor 110 can store information in the memory 115 such as the results of the executed instructions. For example, the memory 115 can store a copy of instructions from a program code that is to be executed by the parallel processor 110 such as program code that represents a machine learning algorithm or neural network. The parallel processor 110 also includes a command processor 150 that receives task requests and dispatches tasks to one or more of the compute units. The command processor 150 is a set of hardware configured to receive the commands from the CPU 105 and to prepare the received commands for processing. For example, in some embodiments the command processor 150 buffers the received commands, organizes the received commands into one or more queues for processing, performs operations to decode or otherwise interpret the received commands, and the like.

Some embodiments of the application 125 utilize an application programming interface (API) 140 to invoke the user mode driver 130 to generate the commands that are provided to the parallel processor 110. In response to instructions from the API 140, the user mode driver 130 issues one or more commands to the parallel processor 110, e.g., in a command stream or command buffer such as command buffer 145. The parallel processor 110 executes the commands in the command buffer 145 provided by the user mode driver 130 to perform operations such as rendering graphics primitives into displayable graphics images and other computing operations such as machine learning. Based on the instructions issued by application 125 to the user mode driver 130, the user mode driver 130 formulates one or more commands that specify one or more operations for the parallel processor 110 to perform. In some embodiments, the user mode driver 130 is a part of the application 125 running on the CPU 105. For example, a gaming or machine learning application running on the CPU 105 can implement the user mode driver 130.

The parallel processor 110 is configured to implement indirect buffers such as command buffer 145 to store commands associated with, for example, an individual program or device driver. For example, in some cases the kernel mode driver 135 employs a command ring buffer to store commands that manage overall operations at the parallel processor 110, and the user mode driver 130 employs an indirect buffer to store commands associated with an executing application. To invoke execution of commands at an indirect buffer, the kernel mode driver 135 stores a specified command, referred to as an indirect buffer execution command, or simply an indirect buffer command, at the command ring buffer. The indirect buffer execution command includes a includes a pointer or other reference to the indirect buffer, so that the parallel processor 110 can, upon executing the indirect buffer command, initiate execution of the commands stored at the corresponding indirect buffer.

The parallel processor 110 receives command buffers 145 (only one is shown in FIG. 1 in the interest of clarity) from the user mode driver 130 of the CPU 105 via the interface 120. The command buffer 145 includes sets of one or more indirect draw and/or dispatch commands for execution by one of a plurality of concurrent graphics pipelines 151, 152. Although two pipelines 151, 152 are shown in FIG. 1, the parallel processor 110 can include any number of pipelines. The parallel processor 110 also includes a prefetcher 155 that fetches blocks of information from the memory 115 for use in executing the one or more indirect draw and/or dispatch commands in some implementations. Queues 160, 161 are associated with the pipelines 151, 152. The queues 160, 161 hold command buffers for the corresponding pipelines 151, 152. In the illustrated embodiment, the command buffer 145 is stored in an entry of the queue 160 (as indicated by the solid arrow 165), although other command buffers received by the parallel processor 110 are distributed to the other queue 161 (as indicated by the dashed arrow 166). The command buffers are distributed to the queues 160, 161 using a round-robin algorithm, randomly, or according to other distribution algorithms.

Command buffer 145 can be implemented as an indirect buffer referenced by a ring buffer (not shown) or other data structure suitable for efficient queuing of work items. Commands from the CPU 105 to the parallel processor 110 can include instructions and data. In some embodiments, data structures having instructions and data are input to a ring buffer by an application and/or operating system executing on CPU 105. A set of indirect buffers such as command buffer 145 are used to hold the commands (e.g., instructions and addresses of data). For example, when CPU 105 communicates a command buffer to the parallel processor 110, the command buffer may be stored in an indirect buffer such as command buffer 145 and a pointer to that indirect buffer can be inserted in the ring buffer.

In some implementations, ring buffer work registers (not shown) are implemented in memory 115 or in other register memory facilities of processing system 100. Ring buffer work registers provide, for example, communication between the CPU 105 and the parallel processor 110 regarding commands in the ring buffers. For example, the CPU 105 as writer of the commands to the ring buffers and the parallel processor 110 as reader of such commands coordinate a write pointer and read pointer indicating the last item added, and last item read, respectively, in the ring buffers. Other information such as a list of available ring buffers and priority ordering specified by the CPU 105 can also be communicated to the parallel processor 110 through ring buffer work registers.

The command processor 150, in at least some implementations, detects when a command buffer 145 is submitted to a hardware queue 160, 161. For example, the command processor 150 detects a doorbell associated with the hardware queue 160. Stated differently, the command processor 150 detects when the user mode driver 130 writes to a doorbell register (not shown) associated with hardware queue 160 and changes the value of the doorbell register. The command processor 150 reads the command packets within the command buffer 145 and decodes the packets to understand what actions need to be performed and dispatches the appropriate commands to the corresponding execution units within the parallel processor 110, such as shader engines 175, fixed-function units, or memory controllers. In at least some implementations, the command processor 150 is implemented as hardware, circuitry, firmware, a firmware-controlled microcontroller, software, or any combination thereof.

A scheduler 170 schedules command buffers from the head entries of the queues 160-162 for execution on the corresponding pipelines 151, 152 and the prefetcher 155, respectively. In some circumstances, the parallel processor 110 operates in a user mode so that shader engines 175 of the parallel processor 110 are able to generate commands in addition to the commands that are received from the user mode driver 130 in the CPU 105. The scheduler 170 schedules the commands for execution on the pipelines 151, 152 or the prefetcher 155. The shader engine 175 provides the commands to the command buffer. In some embodiments, the user mode driver 130 provides one or more first commands to the parallel processor 110, e.g., in the command buffer 145. The scheduler 170 schedules the first commands from the command buffer 145 for execution on one or more of the pipelines 151, 152. In response to completing execution of the first commands, the shader engine 175 identifies or generates one or more second commands for execution. The scheduler 170 then schedules the one or more second commands for execution. For example, if the first commands include a draw call that causes one or more of the pipelines 151, 152 to generate information representing pixels for display, the shader engine 175 generates and the scheduler 170 schedules one or second commands to write (to the memory 115) a block of information including results generated by executing the one or more first commands.

To mitigate memory latencies associated with fetching data, arguments, and state for indirect draw and dispatch commands, the user mode driver 130 and/or the shader engine 175 are configured to interleave prefetch packets with indirect draw commands and indirect dispatch commands at the command buffer 145. By populating the command buffer 145 first with one or more prefetch packets to prefetch data, arguments, and/or state and thereafter with one or more indirect draw or indirect dispatch commands that will consume at least a portion of the prefetched data, arguments, and/or state, the user mode driver 130 and/or the command processor 150 hide memory latencies, minimize stalls, and enhance utilization of the parallel processor 110 and memory bandwidth.

In some implementations, the user mode driver 130 and/or the shader engine 175 populate the command buffer 145 first with one or more prefetch packets, followed by one or more indirect draw or dispatch commands. The user mode driver 130 and/or the shader engine 175 alternates between placing prefetch commands and indirect draw or dispatch commands in the command buffer 145 until the command buffer 145 has reached its maximum capacity in some implementations. The maximum capacity of the command buffer 145 is limited to the lesser of a maximum number of prefetch packets (e.g., 32 prefetch packets) and an amount of storage allocated to store data, arguments, and state specified by the prefetch packets (e.g., N DWORDS). For example, the amount of storage allocated to store data, arguments, and state specified by the prefetch packets may be limited by a storage capacity of the memory 180. Thus, if the cumulative amount of data, arguments, and state specified by the prefetch packets in the command buffer reaches the ceiling of N DWORDS, the command buffer 145 is at its maximum capacity, even if the number of prefetch packets in the command buffer 145 is fewer than the maximum number of prefetch packets.

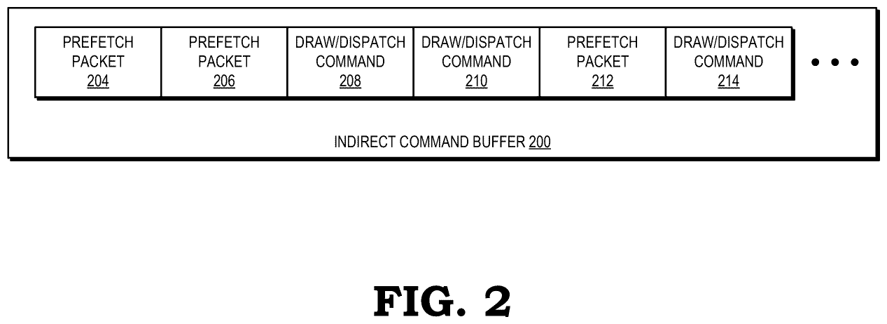

FIG. 2 is a block diagram of an interleaved indirect command buffer 200 in accordance with some embodiments. The first command in the indirect command buffer 200 is a prefetch packet 204. In the illustrated example, the prefetch packet 204 is followed by a second prefetch packet 206. After the prefetch packet 206, the next command to populate the indirect command buffer 200 is an indirect draw or dispatch command 208, followed by another indirect draw or dispatch command 210. By placing the prefetch packets 204, 206 first, before any indirect draw or dispatch commands, the user mode driver 130 or the command processor 150 incurs an initial latency while the data indicated by the prefetch packets 204, 206 is fetched. However, any latencies associated with fetching data indicated by subsequent prefetch packets in the indirect command buffer 200 are partially or fully hidden by execution of the indirect draw and/or dispatch commands that follow.

Following indirect draw or dispatch command 210, the interleaving pattern for the indirect command buffer 200 switches from two prefetch packets (prefetch packets 204, 206) followed by two indirect draw or dispatch commands (indirect draw or dispatch commands 208, 210) to one prefetch command 212 followed by one indirect draw or dispatch command 214. Thus, the cadence of interleaving between prefetch packets and indirect draw or dispatch commands is not necessarily static within the indirect command buffer 200 but can vary as shown in the illustrated example.

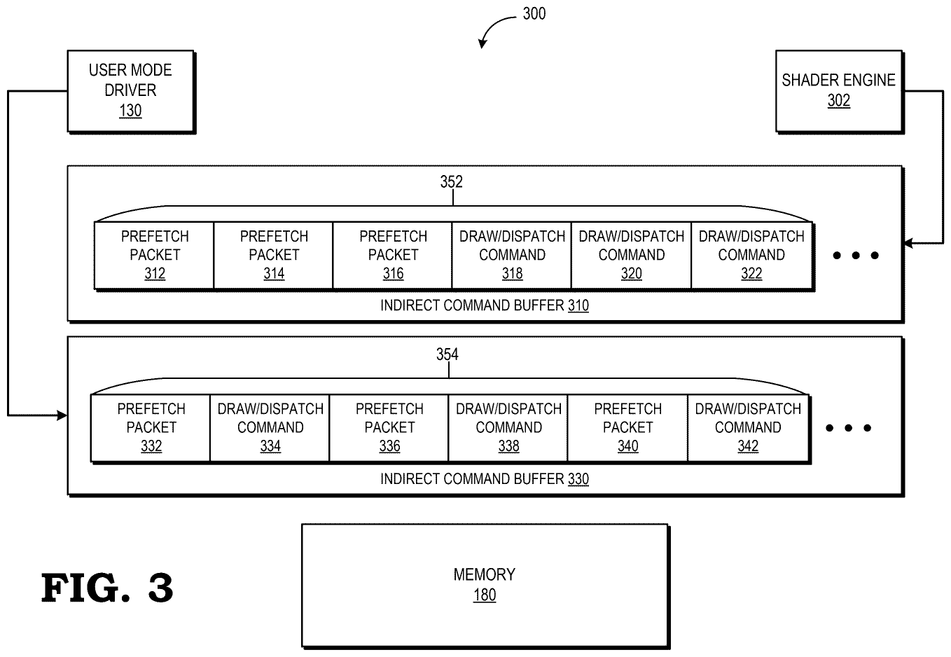

FIG. 3 is a block diagram 300 illustrating interleaving of indirect command buffers 310, 330 based on local memory constraints in accordance with some embodiments. In the illustrated example, the shader engine 175 populates the indirect command buffer 310 and the user mode driver 130 populates the indirect command buffer 330.

The user mode driver 130 and the shader engine 175 set interleaving patterns for the indirect command buffer 310 and the indirect command buffer 330, respectively, based on physical constraints of the memory 180 in some implementations. For example, if the data, arguments, and state that are prefetched based on prefetch packets stored at the indirect command buffer 310 are to be stored at the memory 180 (e.g., for quick access by the parallel processor 110 in execution of indirect draw commands and/or indirect dispatch commands stored at the indirect command buffer 310), the cumulative amount of data, arguments, and state indicated by the prefetch packets stored at the indirect command buffer 310 cannot exceed the storage capacity of the memory 180 (e.g., 1000 DWORDS). It is noted that the indirect command buffers 310, 330 are committed and read by the command processor 150 in sequence, so while each command buffer is subject to memory constraints, the prefetch packets of both command buffers combined do not need to fit within the memory constraints.

In the illustrated example, the shader engine 175 selects an interleaving pattern 352 for the indirect command buffer 310 that places three prefetch packets 312, 314, 316 at the beginning of the indirect command buffer 310, followed by three indirect draw or dispatch commands 318, 320, 322. In some implementations, the shader engine 175 selects the interleaving pattern 352 based on an assessment that the interleaving pattern 352 will minimize latency. The initial three prefetch packets 312, 314, 316 incur a latency penalty, but once the data, arguments, and state indicated by the prefetch packets 312, 314, 316 has been fetched to the memory 180, the indirect draw or dispatch commands 318, 320, 322 can execute without having to wait for their data, arguments, and state. If the memory 180 still has capacity to store additional data beyond the data, arguments, and state indicated by the prefetch packets 312, 314, 316, the shader engine 175 can add more prefetch packets and indirect draw and dispatch commands to the command buffer 310. While the parallel processor 110 is executing the three indirect draw or dispatch commands 318, 320, 322, the prefetcher 155 can prefetch data indicated by the next prefetch packet (not shown), thus hiding latency associated with the next prefetch packet.

In some implementations, the shader engine 175 generates prefetch packets that overestimate the amount of data, arguments, and state that will be consumed by the subsequent indirect draw and/or dispatch commands. For example, a prefetch packet may indicate that the command processor 150 is to prefetch 800 DWORDS. However, the indirect draw command that follows the prefetch packet consumes only 200 DWORDS of the 800 DWORDS that were prefetched. The command processor 150 determines if the remaining 600 DWORDS are to be consumed by a subsequent indirect draw or dispatch command (i.e., if they are indicated in a subsequent prefetch packet). If some or all of the remaining 600 DWORDS are to be consumed by a subsequent indirect draw or dispatch command, the command processor 150 skips the one or more subsequent prefetch packets indicating the remaining 600 DWORDS. If the remaining 600 DWORDS are not described in a subsequent indirect draw or dispatch command (i.e., if they are not needed), the command processor 150 discards them in some implementations. In either case (whether the remaining 600 DWORDS result in skipping one or more subsequent prefetch packets or they are discarded), the command processor 150 frees up capacity in the indirect command buffer 310 for additional commands that are within the capacity of the memory 180. Thus, the number of prefetch packets stored in the indirect command buffer 310 is adjusted based on the amount of prefetched data, arguments, and state consumed by the indirect draw/dispatch commands in the indirect command buffer 310 in some implementations.

In contrast to the indirect command buffer 310, the user mode driver 130 populates the indirect command buffer 330 using an interleaving pattern 354 in which each prefetch packet is followed by an indirect draw or dispatch command. Thus, the first command in the indirect command buffer 330 is prefetch packet 332, which is followed by indirect draw/dispatch command 334, prefetch packet 336, indirect draw/dispatch command 338, prefetch packet 340, and indirect draw/dispatch command 342. Assuming that the capacity of the memory 180 allocated for storing prefetched data, arguments, and state is 1000 DWORDS, and that the indirect command buffer 330 can hold up to 32 prefetch packets, the user mode driver 130 can continue to populate the indirect command buffer 330 in interleaved fashion by alternating prefetch packets with indirect draw/dispatch commands until either the indirect command buffer 330 contains 32 prefetch packets or the aggregate amount of data, arguments, and state described by the prefetch packets in the indirect command buffer 330 totals 1000 DWORDS, whichever comes first.

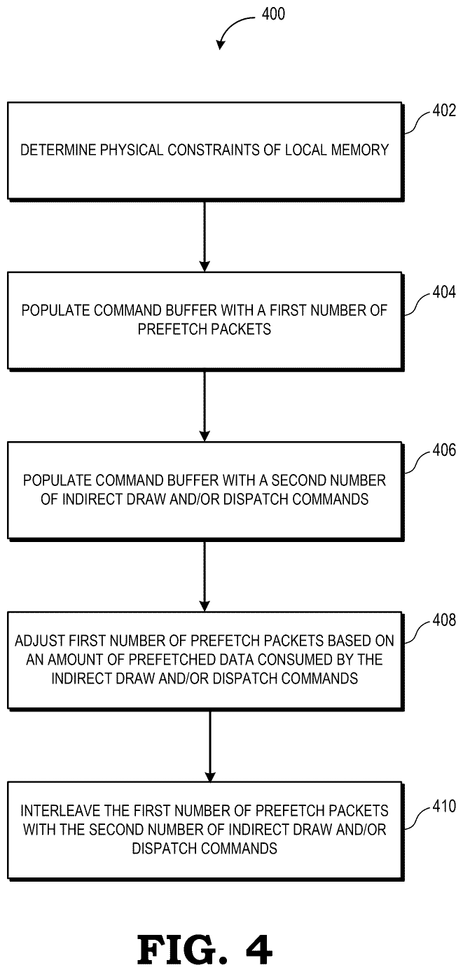

FIG. 4 is a flow diagram illustrating a method 400 for interleaving indirect prefetch commands with indirect draw and indirect dispatch commands at a command buffer in accordance with some embodiments. In some embodiments, the method 400 is implemented at a processing system such as processing system 100.

At block 402, the entity that is populating the indirect command buffer 145 (i.e., either the user mode driver 130 or the shader engine 175) determines the physical constraints of the local memory 180. For example, if the local memory 180 can hold up to 1000 DWORDS of data, the number of prefetch packets in the indirect command buffer 145 will be limited to a number of prefetch packets that call for prefetching up to 1000 DWORDS. Thus, if a first prefetch packet calls for prefetching 200 DWORDS, a second prefetch packet calls for prefetching 400 DWORDS, a third prefetch packet calls for prefetching 100 DWORDS, and a fourth prefetch packet calls for prefetching 300 DWORDS, the capacity of the local memory 180 will be filled with those four prefetch packets. However, if the amount of data indicated by each prefetch packet is lower (e.g., 20 DWORDS each), and the indirect command buffer has a capacity to hold up to 32 prefetch packets, then all 32 prefetch packet slots may be used, because the local memory 180 has capacity to store all the data indicated by all of the 32 prefetch packets.

At block 404, the entity that is populating the indirect command buffer 145 populates the indirect command buffer 145 with a first number of prefetch packets based on the capacity of the local memory 180.

At block 406, the entity that is populating the indirect command buffer 145 populates the indirect command buffer 145 with a second number of indirect draw commands and/or indirect dispatch commands that consume some or all of the data, arguments, and state prefetched based on the prefetch packets.

At block 408, the number of prefetch packets is adjusted in some implementations based on how much of the data, arguments, and state described by the prefetch packets is actually indicated for consumption by the indirect draw and/or dispatch commands.

At block 410, the entity that is populating the indirect command buffer 145 interleaves the first number of prefetch packets with the second number of indirect draw and/or dispatch commands. In some implementations, the user mode driver 130 or the shader engine 175 selects an interleaving pattern that is designed to hide the latency associated with prefetching the data, arguments, and state with execution of indirect draw or dispatch commands. In some implementations, the interleaving pattern alternates between a first number of prefetch packets and a second number of indirect draw or dispatch commands. For example, in some implementations, the interleaving pattern is N prefetch packets: M indirect draw/dispatch commands: N prefetch packets: M indirect draw/dispatch commands, etc. In some implementations, N equals M. By employing indirect command buffers that interleave prefetch packets with indirect draws and dispatches, the user mode driver 130 and/or the shader engine 175 effectively hide memory latencies, minimize stalls, and enhance utilization.

In some embodiments, the apparatus and techniques described above are implemented in a system including one or more integrated circuit (IC) devices (also referred to as integrated circuit packages or microchips), such as the processing system described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
populating a command buffer with commands comprising prefetch packets, and at least one of indirect draw commands and indirect dispatch commands;
interleaving, at the command buffer, the prefetch packets with at least one of the indirect draw commands and the indirect dispatch commands; and
executing at least one of the indirect draw commands and the indirect dispatch commands while prefetching data indicated by a prefetch packet.

2. The method of claim 1, wherein the interleaving comprises populating the command buffer with at least one prefetch packet followed by at least one indirect draw command or at least one indirect dispatch command.

3. The method of claim 1, wherein a number of prefetch packets stored at the command buffer is limited by an amount of memory allocated to store data that is prefetched in response to the prefetch packets.

4. The method of claim 1, wherein populating comprises populating the command buffer with commands generated by at least one of a driver of a central processing unit and a command processor of a parallel processor.

5. The method of claim 1, wherein the interleaving comprises alternating between a first number of prefetch packets and a second number of indirect draw commands or indirect dispatch commands.

6. The method of claim 5, wherein the first number equals the second number.

7. The method of claim 5, wherein the first number is based on an amount of data included in the prefetch packets.

8. The method of claim 7, wherein the first number is further based on an amount of prefetched data that is consumed by one or more of the indirect draw commands or the indirect dispatch commands.

9. A parallel processor comprising:
a local memory; and
a command buffer configured to store commands comprising prefetch packets interleaved with at least one of indirect draw commands and indirect dispatch commands for execution by the parallel processor, wherein the parallel processor is configured to execute at least one of the indirect draw commands and the indirect dispatch commands while prefetching data indicated by a prefetch packet.

10. The parallel processor of claim 9, wherein a number of prefetch packets stored at the command buffer is limited by an amount of the local memory allocated to store data that is prefetched in response to the prefetch packets.

11. The parallel processor of claim 9, further comprising:
a command processor, wherein the command buffer is configured to be populated with commands generated by at least one of a driver of a central processing unit and the command processor.

12. The parallel processor of claim 11, wherein at least one of the driver and the command processor sets an interleaving pattern for the command buffer comprising alternating between a first number of prefetch packets and a second number of indirect draw commands or indirect dispatch commands.

13. The parallel processor of claim 12, wherein the first number equals the second number.

14. The parallel processor of claim 12, wherein the first number is based on an amount of data included in the prefetch packets.

15. The parallel processor of claim 14, wherein the first number is further based on an amount of prefetched data that is consumed by one or more of the indirect draw commands or the indirect dispatch commands.

16. A processing system, comprising:
a central processing unit; and
a parallel processor comprising:
a local memory; and
a command buffer configured to store commands comprising prefetch packets interleaved with indirect draw commands and indirect dispatch commands for execution by the parallel processor, wherein the parallel processor is configured to execute at least one of the indirect draw commands and the indirect dispatch commands while prefetching data indicated by a prefetch packet.

17. The processing system of claim 16, wherein a number of prefetch packets stored at the command buffer is limited by an amount of the local memory allocated to store data in response to the prefetch packets.

18. The processing system of claim 16, wherein the parallel processor further comprises:
a command processor, wherein the command buffer is configured to be populated with commands generated by at least one of a driver of the central processing unit and the command processor.

19. The processing system of claim 16, wherein the commands are interleaved at the command buffer according to an interleaving pattern comprising alternating between a first number of prefetch packets and a second number of indirect draw commands or indirect dispatch commands.

20. The processing system of claim 19, wherein the first number is based on an amount of data included in the prefetch packets.
